(19) United States
(12) Patent Application Publication
(10) Pub. No.: US 2010/0332406 A1
(43) Pub. Date: Dec. 30, 2010

(54) METHOD AND APPARATUS FOR TRANSPORTING A SET OF ARTICLES TO DESTINATIONS AND FOR ANALYZING THE TRANSPORTATION PROCESS

(75) Inventor: Georg Kinnemann, Bestensee (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/826,853

(22) Filed: Jun. 30, 2010

(30) Foreign Application Priority Data
Jun. 30, 2009 (DE) 10 2009 031 160.2

(51) Int. Cl. G06Q 50/00

(52) U.S. Cl. 705/330

(57) ABSTRACT

A method and an apparatus for transporting a set of articles to destinations, particularly items of mail to delivery addresses. The articles to be transported are placed into a transportation apparatus and the filled transportation apparatus and also a portable position measuring instrument are transported along the route. At each destination on the route, the following step is performed: each article which is provided with details relating to the destination is taken from the transportation apparatus, and the transportation for the article is concluded. The position measuring instrument carried along measures its own current geoposition during the transportation at each prescribed measurement time and stores the measured geoposition together with an identification for the measurement time. The interval between two prescribed measurement times is shorter than the period of time for transporting the position measuring instrument from one destination to the next destination on the route. Following conclusion of the transportation, the stored geopositions and measurement times are evaluated in order to ascertain what value is assumed by at least one parameter describing the transportation for this route.

### CROSS-REFERENCE TO RELATED APPLICATION

This application claims the priority, under 35 U.S.C. §119, of German patent application DE 10 2009 031 160.2, filed Jun. 30, 2009; the prior application is herewith incorporated by reference in its entirety.

### BACKGROUND OF THE INVENTION

### Field of the Invention

The invention relates to a method and an apparatus for transporting a set of articles to destinations, particularly for transporting mail items to delivery addresses.

For decades, the following method has been known: a postal carrier transports a container containing mail items to various delivery addresses, so that the container is transported along a delivery route. On the way, the postal carrier delivers each mail item in a container according to its respective delivery address.

A generic method and a device are described in U.S. patent application publication No. US 2007/0250211 A1. There, there is disclosed a method for analyzing a transportation process, wherein the transportation process transports a plurality of articles to a respective destination. Each article to be transported is provided with details relating to a respective destination to which the article is to be transported,

wherein each article is transported along a prescribed route to the respective destination. At least one portable position measuring instrument analyzes the transportation process. The analysis comprises the steps that:

the position measuring instrument is transported along a prescribed route,

the position measuring instrument repeatedly measures its own current geoposition during the transportation and stores an identification for the measured geoposition together with an identification for the respective measurement time,

following conclusion of the transportation of the at least one position measuring instrument, the stored geoposition identifications and measurement time identifications are evaluated in order to ascertain what value is assumed by at least one parameter describing the transportation of the position measuring instrument.

In other words, the publication US 2007/0250211 A1 describes a method for automatically checking transportation routes within a logistical network. A quality test letter (QTL) is transported as a mail item within the logistical network. An expert system produces possible transportation routes within said logistical network beforehand, including target transportation times for the individual sections of the transportation routes in the logistical network. For this, the expert system applies prescribed rules, e.g. for conveying mail items. Next, a plurality of quality test letters are sent within said logistical network. The actually used transportation routes with the actually measured transportation times are compared with the target transportation routes and target transportation times. This ascertains weaknesses in the logistical network.

The publication also describes a configuration for analyzing a transportation process, wherein the transportation process transports a plurality of articles to a respective destination, and wherein each article to be transported is provided with details relating to a respective destination to which said article is to be transported. The configuration comprises a portable position measuring instrument and an evaluation unit. The position measuring instrument is designed to repeatedly measure its own geoposition during transportation along a route and to store an identification for the measured geoposition together with an identification for the respective measurement time, the evaluation unit is designed to evaluate stored identifications for geopositions and measurement times, the configuration is designed to analyze the transportation process by performing the above-outlined process, while the articles together with the position measuring instrument are transported to their respective destinations.

Patent application publication No. US 2008/0258970 A1 and German published patent application DE 10 2007 018633 A1 describe a method and an apparatus for measuring the period of time which is required for the transportation of a mail item. A “transit time tester” used for measurement has a GPS receiver and also an acceleration sensor. Ambient conditions are taken as a basis for switching the GPS receiver on and off in order to save energy.

The “transit time tester” is transported and delivered as an ordinary mail item. Preferably, an acceleration sensor in the transit time measuring instrument periodically measures the acceleration which affects the mail item with the transit time measuring instrument.

Patent application publication No. US 2007/0265876 A1 describes a method for producing and updating a network with destinations for the delivery of mail items.

Patent application publication No. US 2004/0030661 A1 describes how a sorting order for the route (“delivery sequence”) of a postal carrier (“delivery sequence sort plan”) is generated automatically. This involves the following factors being taken into account: the number of incoming mail items broken down according to “ZIP Codes”, the thicknesses and weight of the mail items, the current routes of the mailmen and further information.

Patent application publication No. US 2008/0109678 A1 proposes analyzing the transportation routes for mail items and eliminating errors during transportation, particularly for cross-border transportation.

U.S. Pat. No. 7,031,959 B2 describes a method for managing and updating a database with information about various kinds of delivery points for mail items.

A postal carrier in the US postal service frequently uses a transportation apparatus with various pockets (“cells”). U.S. Pat. No. 7,390,986 B2 describes a method for dividing up mail items into these pockets and in so doing taking account of the route of the postal carrier and dimensions of the mail items. If required, pockets are complemented.

Patent application publication No. US 2008/0015884 A1 describes how instructions are transmitted to a postal carrier on a mobile appliance. This is done by evaluating operating logs relating to the delivery of mail items in the past (“shipping activities”).

U.S. Pat. No. 7,079,981 B2 proposes checking the transportation of mail items by feeding at least one special letter (“seed letter”) into the transportation system in line with a prescribed plan, logging the transportation of said at least one special letter and evaluating the operating logs. Patent application publication No. US 2007/0078793 A1 proposes that a mail customer be able to feed his own random sample of mail items into the distribution system of the US postal service and be able to track the transportation of said mail items.

Patent application publication No. US 2008/0189236 A1 describes a method for analyzing the transportation of goods in a “delivery chain network”. The transportation of goods along various routes is logged. A comparative evaluation is produced from the logged data records for various routes.

European published patent application EP 1762306 A2 describes a method for generating a delivery route for the delivery of mail items and for sorting mail items into two sorting passes in line with said delivery route. In the first sorting pass, the respective delivery address of each mail item is read. In the second sorting pass, a check is performed to determine whether the mail items have actually been sorted in line with said delivery route.

U.S. Pat. No. 7,385,499 B2 describes a method for checking whether an article has actually been transported to the destination to which it is intended to be transported.

Patent application publication No. US 2006/0184403 A1 proposes providing a database having various delivery routes. It is possible to input the utilization level on each delivery route and also the set of mail items to be delivered in order to select a delivery route and to alter it if required. Each delivery route contains destinations with delivery addresses for mail items. A portable display unit is used to display at least one delivery route together with information about the delivery points on said delivery route. By way of example, a “supervisor” selects said route. A postal carrier can input changes into said display unit.

Patent application publication No. US 2006/0184404 A1 describes a method and an apparatus for dividing up the work of delivering mail items between various mailmen. This involves the provision of a respective database having information about delivery routes, having information about the volume of mail items to be delivered and having information about mailmen and their capacities. By evaluating these three databases, the work is distributed between the mailmen such that the available capacities are utilized as evenly as possible.

Patent application publication No. US 2006/0184405 A1 involves the use of these three databases to utilize the mailmen and their working hours as evenly as possible.

International application publication WO 2002/019046 A1 describes a method and an apparatus for dynamically optimizing the transportation of goods to delivery points. A central computer optimizes the route while the transportation of the goods on said route has already been started. This involves the capture of data about the goods from local processing stations and the transportation of said data to said central computer. A local processing station of this kind captures when the goods reach the station, inter alia. When needed, the central computer alters the next subsection of the route and uses the data from the processing stations for this purpose.

Patent application publication No. US 2004/0186691 A1 describes a data capture appliance (“data acquisition system 100”) which is transported together with a product and can be integrated into the product. The data capture appliance 100 comprises a sensor arrangement 230 which measures ambient conditions, inter alia humidity, temperature, GPS location, acceleration and current time. These measurement data are recorded.

U.S. Pat. No. 6,429,810 B1 describes a method for measuring the current state of a transported container and for transmitting the measured values from a control center. An explicit “transaction code”, which identifies the container, and also status information are transmitted to the control center.

### SUMMARY OF THE INVENTION

It is accordingly an object of the invention to provide a method and a device for transporting a plurality of articles which overcome the above-mentioned disadvantages of the heretofore-known devices and methods of this general type and which provides for an apparatus for measuring at least one parameter for the route with little involvement.

With the foregoing and other objects in view there is provided, in accordance with the invention, a method for analyzing a transportation process, the transportation process transporting a plurality of articles to a respective destination, each article to be transported being provided with details relating to a respective destination to which the article is to be transported, and each article being transported along a prescribed route to the respective destination, the method which comprises:

providing at least one portable position measuring instrument and analyzing the transportation process with the position measuring instrument by:

transporting the position measuring instrument along a prescribed route;

repeatedly measuring a current geoposition of and with the position measuring instrument during the transportation and storing an identification for the measured geoposition together with an identification for a respective measurement time;

following conclusion of the transportation of the at least one position measuring instrument, evaluating the stored geoposition identifications and measurement time identifications in order to ascertain what value is assumed by at least one parameter describing the transportation of the position measuring instrument;

wherein a transportation route is prescribed, the prescribed transportation route stipulating a single order among all times for the articles that are to be transported;

wherein a series of measurement times is prescribed, wherein an interval between two measurement times is shorter than a period of time required to transport the position measuring instrument from one destination to the next destination on the transportation route using the destination order; and

wherein the method further comprises:

placing all articles to be transported into a common transportation apparatus;

transporting the filled, common transportation apparatus together with the position measuring instrument along the entire prescribed transportation route;

measuring the geoposition of the position measuring instrument at each prescribed measurement time and storing an identification for the geoposition and an identification for the measurement time;

at each destination on the transportation route, removing each article that is provided with details relating to the destination from the transportation apparatus and concluding a transportation for the respective article; and

using a parameter value ascertained by evaluating the stored geoposition and measurement times as a parameter value for the transportation route.

In other words, the solution according to the invention involves the provision of a method and an arrangement for transporting a plurality of articles to destinations.

Each article to be transported is provided with details relating to a respective possible destination. Each “destination” on the route has its own geoposition. Different destinations are distinguished by different geopositions.

A route is prescribed which stipulates an order among a set of possible destinations. The order comprises all destinations for the articles which are to be transported.

In addition, a series of measurement times is prescribed. The interval between two measurement times is shorter than the period of time which is required for transporting the position measuring instrument from one destination to the next destination on the transportation route using the destination order.

The method according to the invention comprises the following steps:

All articles to be transported are placed into the same transportation apparatus.

The filled transportation apparatus and also a portable position measuring instrument are transported along the route.

At each destination on the route, the following step is performed: each article which is provided with details relating to said destination is taken from the transportation apparatus, and the transportation for said article is concluded.

The position measuring instrument carried along measures its own current geoposition at each prescribed measurement time in the series during the transportation and stores an identification for said measured geoposition together with an identification for the respective measurement time. The interval between two prescribed measurement times is shorter than the period of time for transporting the position measuring instrument from one destination to the next destination on the route.

Following conclusion of the transportation, the stored geopositions and measurement times are evaluated in order to ascertain what value is assumed by at least one parameter describing the transportation for said route.

The invention dispenses with the need to calculate target transportation times in advance and to compare them with measured actual transportation times. On the contrary, the invention can be used in exactly the same way when no such transportation times are yet known.

The invention allows the transportation route to be analyzed while articles are being transported along said transportation route to their respective delivery points. It is therefore possible to analyze the transportation route in normal operation, that is to say while the articles are being delivered in normal operation. By way of example, it is possible to analyze a prescribed delivery sequence (“delivery point sequence”) for a postal carrier (“carrier, facteur”) while the postal carrier delivers mail items in line with said delivery sequence. It is not necessary to perform a separate transportation process specifically for the purpose of analyzing the transportation route. On the contrary, the invention allows the normal transportation of the articles to be logged and the operating logs (with geopositions, accelerations and times) to be evaluated. The position measuring instrument may resemble an article to be transported, e.g. a mail item, or may be in a different form and, by way of example, have a shape which is able to hold a power supply for the position measuring instrument in optimum fashion.

The invention does not require a destination or another point on the route to be equipped with a data memory or a reader in order to ascertain the position of said destination. Such equipment would require investment in equipment for the infrastructure, for example because mailboxes would need to be equipped with RFID chips. The invention allows the position measuring instrument to measure the respective position of each destination automatically. It is not necessary to configure the destination with a special piece of equipment.

The invention dispenses with the need for the transportation apparatus to be accompanied on its route by a logging human who logs when the transportation apparatus reaches which destination during transportation.

Preferably, the route is entered into a map which is in a computer-evaluatable form. Preferably, the position measuring instrument measures those raw parameters which are needed for the subsequent evaluation, specifically preferably without this requiring the position measuring instrument to interchange data with a form of equipment along the route.

Preferably, a plurality of transportation routes are compared with one another for the same destinations. Each transportation route is prescribed and stipulates a respective order among the same destinations for the articles. This order differs from transportation route to transportation route. A respective position measuring instrument is transported along each transportation route. It is possible to use the same position measuring instrument for each transportation route. If a plurality of position measuring instruments are used, it becomes possible to analyze a plurality of transportation routes at parallel times and in so doing to take or use said routes and to transport articles to the destinations, which saves time.

By way of example, the articles are mail items, and the transportation apparatus is a pocket for mail items or else a vehicle in which mail items are transported.

Other features which are considered as characteristic for the invention are set forth in the appended claims.

Although the invention is described herein as embodied in a method and apparatus for transporting a set of articles to destinations, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments and examples.

### DETAILED DESCRIPTION OF THE INVENTION

In the exemplary embodiment, the transported articles are mail items, e.g. standard letters, large letters, postcards, or else parcels and packets. Each mail item is provided with details relating to a respective delivery address to which the given mail item is to be delivered or sent in another way. The delivery address denotes a recipient and also a particular building (road, house number, town) or a PO box or a package box in a particular box system. “Destination” is subsequently understood to mean this building or this box system. Different delivery addresses may be located at the same destination, e.g. different occupants of an apartment building or different P.O. boxes in the same box system. Different destinations are distinguished by their geo-coordinates.

In the exemplary embodiment, the method is used in order to analyze a plurality of possible delivery routes and then to select a delivery route for a prescribed set of possible destinations in a geographical area. The possible destinations are all houses and box systems in said area, for example. A plurality of alternative delivery routes are prescribed or have been ascertained beforehand. Each delivery route stipulates a respective order among the same possible destinations. The delivery routes may be distinguished by different orders, but in the exemplary embodiment they all comprise the same possible destinations.

Each delivery route is tested using a respective set of mail items. Said set of mail items comprises, by way of example, those mail items which have accumulated up to a particular time since the last delivery in this area and which need to be delivered, anyway, to the delivery addresses which are indicated on the mail items. To make the delivery routes comparable, the day is the same day of the week each time, for example. Although each delivery route relates to the same set of possible destinations, it is possible for a set of mail items to contain no mail item for a particular destination, that is to say no mail items for some delivery address at this destination.

Each set of mail items is transported by a postal carrier along the respective delivery route, and each mail item is delivered to the respective delivery address. The set of mail items is put into at least one container and is transported in said container, e.g. in a container which is known from U.S. Pat. No. 7,390,986 B2. The postal carrier transports the or each filled container along the respective delivery route. At each delivery address, he takes those mail items which are provided with details relating to said delivery address from the respective container and puts them into the mailbox or into the P.O. box or the package box or hands them to the recipient in person.

In line with the solution, the postal carrier carries a portable position measuring instrument with him. Said position measuring instrument has a GPS receiver and is in the form of a GPS logger or else in the form of a GPS quality letter, for example. Such a GPS quality letter is described in US 2008/0258970 A1, for example. Further quality letters are known from US 2007/0250211 A1 and U.S. Pat. No. 6,227,375 B1. GPS loggers are also described in U.S. Pat. No. 7,072,668 B2 and in U.S. Pat. No. 6,657,584 B2.

In the exemplary embodiment, the position measuring instrument also comprises an acceleration sensor. In one refinement, this acceleration sensor is able to quantitatively measure the acceleration experienced by the position measuring instrument. In another refinement, said acceleration sensor is able to distinguish whether the acceleration is above or below a prescribed limit. This other refinement can be implemented by a relatively simple design.

Preferably, the position measuring instrument is put into the container together with the mail items and remains in the container throughout the transportation. Only following conclusion of the transportation is the position measuring instrument taken from the container, and stored data are read.

A series of measurement times is prescribed, e.g. equidistant measurement times. The interval between two successive measurement times in the series is so short that the period of time in which the container is transported from one destination to another destination on the delivery route covers at least one measurement time in the series.

At each measurement time in the series, the position measuring instrument measures
its own current geoposition at said measurement time using the GPS receiver and
the acceleration which the position measuring instrument experiences at said measurement time.

The interval between two successive measurement times in the series is so short that the position measuring instrument carries out at least one measurement while the container and the position measuring instrument are being transported from one destination to another destination. By way of example, the interval between two successive measurement times is 10 seconds.

In addition, the position measuring instrument comprises a data memory. Said data memory is used to store, for each measurement time, the respective geoposition measured therefor, the acceleration and also an identification for the measurement time itself. The measurement time is stored as a continuous index or as a system clock time, for example.

When the postal carrier has taken a respective delivery route and has delivered the mail items, the data stored in the position measuring instrument are transmitted to an evaluation unit, e.g. by virtue of the data memory being periodically taken from the position measuring instrument and connected to the evaluation unit or by virtue of a data link being periodically set up between the data memory in the position measuring instrument and the evaluation unit. The evaluation unit evaluates the two transmitted measurement series (geopositions and acceleration values). As a result, the evaluation unit ascertains when the postal carrier has stopped at a destination in order to deliver mail items to the delivery points at said destination. Furthermore, the evaluation unit ascertains when the postal carrier has left the delivery point again in order to move on or drive on. On account of the sampling rate in the exemplary embodiment having been chosen to be sufficiently short (e.g. 10 seconds), the evaluation unit automatically establishes for each delivery point how long the postal carrier has stopped at said delivery point. In order to establish this length of stay, the evaluation unit preferably also evaluates the logged data about the acceleration.

It is possible for the position measuring instrument not to be able to measure its own geoposition at particular measurement times, for example because it cannot receive signals from a GPS satellite. The acceleration values which are measured between two measurement times with signal reception are used in order to determine at least approximately the geopositions not measured directly at the measurement times without signal reception.

Using this information, the evaluation unit automatically ascertains what values are assumed by the following parameters for this delivery route:
number of destinations on this delivery route,
time involvement for all articles (mail items) to be delivered by the transportation along the delivery route,
average length of stay for the container and for the position measuring instrument at a destination
average time involvement for the distance from one destination to the next destination on the delivery route,
maximum acceleration throughout the delivery route,
the acceleration as a function of the distance throughout the delivery route.

A rating function is prescribed which is dependent on at least one of the measured parameters. For each delivery route, the evaluation unit has ascertained the respective parameter values by evaluating the measurement series for said delivery route. The evaluation unit applies the rating function to the respective parameter values for a complete delivery route or to a portion of a delivery route and thereby calculates a rating for said delivery route or delivery route portion. The delivery route with the best rating is selected and is used for the future delivery of mail items to the delivery addresses in this area. It is also possible for the ratings to be used to compare various portions of a delivery route with one another.

In one refinement, the measured values which have been measured during delivery along a route are conditioned and entered into an electronic map. Said map comprises reference points and, for each reference point, the geoposition thereof.

The representation produced clearly shows at what times the postal carrier reached what delivery point on the route and what acceleration values arose at that point. In addition, the conditioning unit knows how many mail items are to be transported to which delivery point in each case. These numbers can also be entered and automatically linked to the measured values.

The measurement series with geopositions and measurement times stipulates the delivery route, wherein the measurement series stipulates a respective point on the delivery route for each measurement time. The reference points and geopositions are used to calculate the relative position of each point on the delivery route relative to reference points on the map, and the point is automatically entered into the map.

It is possible to additionally mark all destinations on the delivery route and to enter information for destinations, e.g. the ascertained distance (length, time required) between two adjacent destinations.

In one refinement, a computer-accessible list with target destinations on the delivery route is prescribed. By evaluating the measurement results, it is established which destinations have actually been reached and which have not. This comparison makes it possible to establish whether all target destinations in a prescribed list have actually been reached.

This map with the delivery route can be used as a guideline for mailmen so that they find the selected delivery route quickly. There is no need to log the delivery route manually and to enter it manually into the map.

1. A method for analyzing a transportation process, the transportation process transporting a plurality of articles to a respective destination, each article to be transported being provided with details relating to a respective destination to which the article is to be transported, and each article being transported along a prescribed route to the respective destination, the method which comprises:
providing at least one portable position measuring instrument and analyzing the transportation process with the position measuring instrument by:
transporting the position measuring instrument along a prescribed route;
repeatedly measuring a current geoposition of and with the position measuring instrument during the transportation and storing an identification for the measured geoposition together with an identification for a respective measurement time;
following conclusion of the transportation of the at least one position measuring instrument, evaluating the stored geoposition identifications and measurement time identifications in order to ascertain what value is assumed by at least one parameter describing the transportation of the position measuring instrument;
wherein a transportation route is prescribed, the prescribed transportation route stipulating a single order among all times for the articles that are to be transported;
wherein a series of measurement times is prescribed, wherein an interval between two measurement times is shorter than a period of time required to transport the position measuring instrument from one destination to the next destination on the transportation route using the destination order; and
wherein the method further comprises:
placing all articles to be transported into a common transportation apparatus;
transporting the filled, common transportation apparatus together with the position measuring instrument along the entire prescribed transportation route;
measuring the geoposition of the position measuring instrument at each prescribed measurement time and storing an identification for the geoposition and an identification for the measurement time;
at each destination on the transportation route, removing each article that is provided with details relating to the destination from the transportation apparatus and concluding a transportation for the respective article; and
using a parameter value ascertained by evaluating the stored geoposition and measurement times as a parameter value for the transportation route.

2. The method according to claim 1, wherein the step of evaluating the geopositions and measurement times ascertains a value of at least one of the following parameters:
a total time for transporting the transportation apparatus along the route;
average length of stay for the transportation apparatus at each destination on the route; and
average time for transporting the transportation apparatus between two successive destinations on the route.

3. The method according to claim 1, which further comprises:
additionally measuring and storing with the position measuring instrument, at each measurement time, an acceleration to which the position measuring instrument is subject at the measurement time; and
additionally ascertaining a value of at least one of the following parameters:
a maximum acceleration of the position measuring instrument during transportation;
an average acceleration of the position measuring instrument between two destinations on the route.

4. The method according to claim 1, which further comprises:
prescribing a further route that stipulates a different order among the same possible destinations;
performing a transportation to destinations for further articles by transporting the further articles along the further route together with a position measuring instrument; and
ascertaining what value is assumed by the at least one parameter for the further route.

5. The method according to claim 4, which further comprises:
comparing the two routes with one another by applying a prescribed rating specification
to the parameter value or values for the route; and
to the parameter value or values for the further route; and
generating a respective rating for each route.

6. The method according to claim 5, which comprises using the route ratings to automatically select one of the two routes, and transporting a third set of articles which are provided with details relating to possible destinations from the set of destinations along the selected route.

7. The method according to claim 1, which comprises transporting the position instrument in or on the transportation apparatus throughout the transportation.

8. The method according to claim 1, which comprises prescribing an electronic map for an area that includes all possible destinations, and using the measured geopositions to automatically enter the route into the map.

9. The method according to claim 1, which further comprises:
prescribing a computer-accessible listing containing the target destinations on the route; and
wherein the step of evaluating the stored geopositions and measurement times following conclusion of the transportation includes the steps of:
ascertaining which destinations have actually been reached during the transportation; and
producing a comparison of the actually reached destinations with the prescribed target destinations.

10. A configuration for analyzing a transportation process, wherein a plurality of articles are transported to a respective destination, and wherein each article to be transported is provided with details relating to a respective destination to which the article is to be transported, the configuration comprising:
a portable position measuring instrument configured to repeatedly measure its own geoposition during transportation along a route and to store an identification for the measured geoposition together with an identification for the respective measurement time;
an evaluation unit configured to evaluate stored identifications for geopositions and measurement times;
wherein the configuration is configured to analyze the transportation process by performing the following steps, while the articles together with said position measuring instrument are being transported to their respective destinations:
said position measuring instrument repeatedly measures a current geoposition thereof during transportation along a prescribed route and stores the geoposition and an identification for the respective measurement time;
following conclusion of the transportation process, said evaluation unit evaluates the identifications stored by said position measuring instrument for geopositions and measurement times and thereby ascertains what value is assumed by at least one parameter describing the transportation of the position measuring instrument,
the configuration further comprising a transportation apparatus, said transportation apparatus being configured:
to carry the articles to be transported;
to be transported along a prescribed transportation route; and
at each destination on the route, enable each article that is provided with details relating to the destination to be is taken from said transportation apparatus such that a transportation for the article is concluded;
wherein:
all articles to be transported are placed into the transportation apparatus, the filled transportation apparatus is transported together with the position measuring instrument along a prescribed transportation route, the transportation route stipulating a single order among all destinations for the articles which are to be transported; and
throughout the transportation along the transportation route, the position measuring instrument measures its own current geoposition at each measurement time in a series of prescribed measurement times and stores an identification for the measured geoposition and an identification for the respective measurement time; and
an interval between two measurement times in the series is shorter than the period of time which is required for transporting the position measuring instrument from one destination to the next destination on the transportation route using the destination order.

11. The configuration according to claim 10, wherein said position measuring instrument is shaped and dimensioned to resemble an article to be transported and said position measuring instrument is transported in the transportation apparatus.

12. The configuration according to claim 10, which further comprises an acceleration sensor configured to at least approximately measure and store, during transportation, at each measurement time, a current acceleration of the transportation apparatus at the measurement time, and wherein said evaluation unit is configured to additionally evaluate the stored acceleration values during the evaluation performed following the conclusion of the transportation.
